(19) United States
(12) Patent Application Publication
(10) Pub. No.: US 2002/0152563 A1
(43) Pub. Date: Oct. 24, 2002

(54) Toothbrush and electric toothbrush

(76) Inventor: Masanori Sato, Shimane (JP)

Correspondence Address: Irving M. Weiner, Weiner & Burt, P.C., 635 N. US-23, P.O. Box 186, Harrisville, MI, 48740, US

(21) Appl. No.: 10/022,188

(22) Filed: Dec. 13, 2001

Related U.S. Application Data
(62) Division of application No. 09/609,252, filed on Jun. 30, 2000, now Pat. No. 6,334,232.

(51) Int. Cl. A46B 9/04; A61C 17/22

(52) U.S. Cl. 15/22.1; 15/167.2

(57) ABSTRACT

Various embodiments of novel toothbrush bodies are provided. In one embodiment, a first toothbrush body has a handle, while two other toothbrush bodies are attached are attached to the first toothbrush body by curved stainless steel arm pins disposed on opposite sides of the first toothbrush body. Removable nuts are provided to allow the other two toothbrush bodies to be replaced. In another embodiment, three toothbrush bodies have fitting grooves in their outer surfaces, and stainless steel joints having a channel shape are fitted in the grooves. In another embodiment, three toothbrush bodies are integrally joined to each other by a curved stainless steel enclosing plate that is fastened to the bodies by screws. A hard sponge cushion, rather than a bristle assembly, is attached to the lower surface of the toothbrush bodies.

### DETAILED DESCRIPTION OF THE INVENTION

1. Industrial Field

The present invention relates to a toothbrush and an electric toothbrush for efficiently removing plaque, tartar, calculus from teeth.

2. Prior Art

Teeth are an important organ indispensable for the mastication of food and the utterance of speech sounds. In order for the teeth to perform their functions, it is necessary for them to be brushed after meals or before sleeping to prevent tartar and calculus from being deposited on dental necks for protection against periodontites.

For brushing teeth, it has heretofore been customary to use tooth brushes having bristle assemblies planted on an end of a handle. Electric toothbrushes that have been developed in recent years have also been widely used.

Toothbrushes and electric toothbrushes, which are respectively manually and automatically operable, are generally used by turning the bristle assemblies back and forth about the toothbrush axis.

### Problems to be solved by the invention

However, the conventional toothbrushes and electric toothbrushes have suffered the following drawbacks:

When the handle of a toothbrush is rocked about its own axis in use, the bristle assemblies are angularly moved alternately upwardly and downwardly. More specifically, when the user of an electric toothbrush holds its grip cylinder and angularly moves the bristle assemblies about the axis while keeping the bristle assemblies against a tooth side or neck, a downward swinging movement of the bristle assemblies peels an end of the gum off the tooth neck, and pushes a deposit of plaque into a recess that is formed between the peeled gum and the tooth neck. Therefore, the brushing operation tends to produce a deposit of tartar and calculus, causing periodontites such as a dentoalveolitis. [Means for solving the problems]

Means according to the present invention for solving the above problems are as follows:

According to a first invention, a toothbrush comprises:

a grip handle;

a crown cap mounted on a distal end of the grip handle and having a substantially L-shaped cross section and a predetermined length; and

bristle assemblies planted on inner surfaces of wings of the crown cap and having tip ends inclined at a predetermined angle toward a bent corner of the crown cap.

According to a second invention, an electric toothbrush comprises:

a grip base;

a handle mounted on the grip base for reciprocating angular movement at least about an axis thereof by electric actuator means housed in the grip base;

a crown cap mounted on a distal end of the handle and having a substantially L-shaped cross section and a pre-determined length; and

bristle assemblies planted on inner surfaces of wings of the crown cap and having tip ends inclined at a pre-determined angle toward a bent corner of the crown cap.

According to a third invention, in the toothbrush or the electric toothbrush according the first or second invention, the crown cap has adjusting means for adjusting the projection of one of the bristle assemblies, and mounting means for mounting a distal end of the grip handle or the handle detachably on a longitudinal end of the crown cap.

The electric actuator means is not limited to any structure, but may comprise a known means such as a combination of a motor and a cam mechanism.

The mounting means for detachably mounting the grind handle or the handle on the crown cap is not limited any particular structure. The mounting means may be composed of known means, e. g., engaging holes defined in the opposite ends of the crown cap and an engaging body mounted on the distal end of the grip handle or the handle and engaging in one of the engaging holes, or alternatively, an engaging hole defined longitudinally through the crown cap and an engaging shaft mounted on the distal end of the grip handle or the handle and engaging in the engaging hole.

The bristle assemblies are inclined at an angle of 45°, for example, to the inner surfaces of the crown cap. However, the angle of inclination is not limited 45°. The bristle assemblies are not limited to any particular length, but may have the same length or lengths that vary stepwise.

The adjusting means for adjusting the projection of one of the bristle assemblies is not limited to any particular structure, but may be known means, e. g., a screw for moving a base on which the bristle assembly is planted into and out of the crown cap.

According to a fourth invention, a toothbrush comprises:

a grip handle;

a crown cap mounted on a distal end of the grip handle and including a molar tooth fitting portion and a front tooth fitting portion which have respective inner walls corresponding to respective tooth surfaces; and

bristle assemblies planted on the inner walls of the molar tooth fitting portion and the front tooth fitting portion and inclined at an angle ranging from 30° to 60° toward tip ends of molar and front teeth that are fitted in the molar tooth fitting portion and the front tooth fitting portion respectively.

According to a fifth invention, an electric toothbrush comprises:

a grip base;

a handle mounted on the grip base for reciprocating angular movement about an axis thereof or in the direction of a tooth axis, or in the direction normal to the direction of the tooth axis, by electric actuator means housed in the grip base;

a crown cap mounted on a distal end of the handle and including a molar tooth fitting portion and a front tooth fitting portion which have respective inner walls corresponding to respective tooth surfaces; and

bristle assemblies planted on the inner walls of the molar tooth fitting portion and the front tooth fitting portion and inclined at an angle ranging from 30° to 60° toward tip ends of molar and front teeth that are fitted in the molar tooth fitting portion and the front tooth fitting portion respectively.

According to a sixth invention, in the toothbrush or the electric toothbrush according the fourth or fifth invention, the crown cap has only a molar tooth fitting portion and a bristle assembly corresponding thereto.

According to a seventh invention, in the toothbrush or the electric toothbrush according the fourth or fifth invention, the crown cap has only a front tooth fitting portion and a bristle assembly corresponding thereto.

The electric actuator means is not limited to any structure, but may comprise a known means such as a combina tion of a motor and a cam mechanism.

The bristle assemblies should preferably inclined at an angle of 45° to the surfaces of a molar or front teeth that is fitted in the tooth fitting portion. However, the angle of inclination is not limited to 45°, but may be selected in a range from 30° to 60°. The bristle assemblies are not limited to any particular length, but may have the same length or lengths that vary stepwise.

According to an eighth invention, a toothbrush comprises:

a. grip handle; and

a plurality of toothbrush bodies detachably mounted on a distal end of the grip handle;

the toothbrush bodies having bristle assemblies inclined at an angle ranging from 30° to 60° with respect to sides of teeth toward tip ends of the teeth in use.

According to a ninth invention, a toothbrush comprises:

a grip base;

a vibrator mounted on the grip base for vibration in predetermined directions by electric actuator means housed in the grip base; and

a plurality of toothbrush bodies detachably mounted on the vibrator;

the toothbrush bodies having bristle assemblies inclined at an angle ranging from 30° to 60° with respect to sides of teeth toward tip ends of the teeth in use.

The electric actuator means is not limited to any structure, but may comprise a known means such as a combination of a motor and a cam mechanism.

The toothbrush bodies should preferably be attached such that the bristle assemblies are inclined at an angle of 45° with respect to sides of teeth that are inserted. However, the angle of inclination is not limited to 45°, but may be selected in a range from 30° to 60°.

The number of toothbrush bodies may generally range from two to three though not limited to any particular value. If two toothbrush bodies are employed, then they are positioned respectively on the corresponding opposite sides of teeth, or one of them is positioned on the occlusal tooth area of the teeth and the other on one of the sides of the teeth. If three toothbrush bodies are employed, then one of them is positioned on the occlusal tooth area of the teeth and the others on the respective sides of the teeth.

If the angle of inclination of the bristle assemblies were less than 30° or greater than 60°, then they would not sufficiently scrape off plaque or the like because the pressure applied by the tip ends of the bristle assemblies to the tooth surfaces would be weak.

The bristle assemblies are not limited to any particular length, but may have the same length or lengths that vary stepwise.

According to tenth through sixteenth inventions, an electric toothbrush 10 comprises a bristle assembly 16 reciprocally angularly movable to swing upwardly along teeth sides while being held against the teeth sides or neighboring regions, reciprocally rocking means 18 for angularly moving the bristle assembly 16, and an actuator 68 coupled to the reciprocally rocking means 18 (The reference numerals used in this sentence are indicated in FIG. 23, and those in sentences given below are indicated in FIG. 4).

The bristle assembly 16 may be mounted in one side of a casing 14 having a substantially inverted L shape, and a temporary positioning member 54 may be mounted on the other side of the casing 14 for temporarily positioning the bristle assembly 16 for engagement with a tooth side.

The temporary positioning member 54 may comprise a resilient member.

The temporary positioning member 54 may comprise bristles.

The temporary positioning member 54 may be adjustable in height.

The bristle assembly 16 may comprise an upper set of bristles 46 and a lower set of bristles 46, the lower set of bristles 46 being longer than the upper set of bristles 46.

The bristle assembly 16 comprises an upper set of bristles 46, a middle set of bristles 46, and a lower set of bristles 46, the bristles being of longer, shorter, and medium lengths successively from the lower set through the middle set to the upper set. [Operation]

In the first through third inventions, when the toothbrush is used, one of the bristle assemblies is held against the occlusal tooth areas of teeth and the other against the boundaries (tooth necks) between the tooth sides and the gum. If the toothbrush is a manual toothbrush, then the grip handle is manually angularly moved reciprocally about the axis thereof. If the toothbrush is an electric toothbrush, the grip handle is angularly moved reciprocally about the axis thereof by the electric actuator means.

If the toothbrush has the adjusting means for adjusting the projection of one of the bristle assemblies, then the projection of the bristle assembly is adjusted by the adjusting means such that the bristle assembly adjustable by the adjusting means will abut against the occlusal tooth areas of teeth and the other bristle assemblies will abut reliably against the boundaries (the tooth necks) between the tooth sides and the gum.

The toothbrush with the adjusting means has a particular orientation in order to keep the adjustable bristle assembly in abutment against the occlusal tooth areas of teeth at all times. In this structure, therefore, the crown cap can be attached in a different position to change the orientation of the toothbrush for brushing all the surfaces of teeth. Specific details will be described later with respect to embodiments given below.

In the fourth through seventh inventions, when the toothbrush is used, a molar tooth is fitted in the molar tooth fitting portion or a front tooth is fitted in the front tooth fitting portion. Each of the bristle assemblies is held in contact with the surface of the tooth at an angle ranging from 3° to 60°. If the toothbrush is a manual toothbrush, then the grip handle is manually angularly moved reciprocally about the axis thereof, or in the direction of the tooth axis, or in the direction normal thereto. If the toothbrush is an electric toothbrush, the grip handle is angularly moved reciprocally about the axis thereof, or in the direction of the tooth axis, or in the direction normal thereto, by the electric actuator means.

In the eighth and ninth inventions, when the toothbrush is used, a tooth is fitted in the space surrounded by the bristle assemblies. The bristle assemblies positioned on tooth sides are held in contact with the tooth sides at an angle ranging from 30° to 60°. If the toothbrush is a manual toothbrush, then the grip handle is manually vibrated about the axis thereof, or in the direction of the tooth axis, or in the direction normal thereto. If the toothbrush is an electric toothbrush, the grip handle is vibrated about the axis thereof, or in the direction of the tooth axis, or in the direction normal thereto, by the electric actuator means.

In the tenth through sixteenth inventions, when the electric toothbrush is used to brush a tooth, the bristle assembly is brought into abutment against a side or neck of the tooth while being held substantially horizontally, and angularly moved reciprocally so as to swing upwardly by the reciprocally rocking means coupled to the actuator.

The bristle assembly may be mounted in one side of - l i the casing of a substantially inverted L shape, and the temporary positioning member may be mounted on the other side of the casing for temporarily positioning the bristle assembly for engagement with the tooth side. The temporary positioning member can be held against the occlusal tooth area of the tooth crown for thereby accurately holding the bristle assembly against the tooth side or the tooth neck for scraping off deposited plaque.

The temporary positioning member may comprise a resilient member or bristles, and may be adjustable in height. This arrangement allows the temporary positioning member to hold the bristle assembly accurately against a tooth surface ranging from the tooth side to the tooth neck without slipping over the occlusal tooth area of the tooth crown.

The bristle assembly may comprise an upper set of bristles and a lower set of bristles, the lower set of bristles being longer than the upper set of bristles. Alternatively, the bristle assembly may comprise an upper set of bristles, a middle set of bristles, and a lower set of bristles, the bristles being of longer, shorter, and medium lengths successively from the lower set through the middle set to the upper set. With this arrangement, the bristles of the bristle assembly can abut against a curved tooth surface along the tooth side and the tooth neck for effectively removing plaque.

In any of the first through sixteenth inventions, since the bristle assemblies, though they are angularly movable reciprocally, are planted so as to be inclined to the tooth surface, the frictional force is stronger upon angular movement toward the tip end of the tooth, and weaker upon angular movement in the opposite direction. Therefore, plaque, tartar, and calculus deposited on the occlusal tooth area, the tooth side, and the tooth neck are gathered toward the center of the tooth fitting portion. For the same reason, the gum is not peeled off the tooth neck, and plaque, tartar, and calculus deposited on the tooth neck are removed without being pushed between the tooth and the gum. [Embodiments]

First through third inventions will be described in detail below based on embodiments shown in the drawings.

FIG. 1 is an exploded perspective view of a toothbrush according to an embodiment of the present invention. FIG. 2 is a view illustrative of the structure and operation of bristle assemblies of the toothbrush. FIG. 3 is an enlarged view of tip ends of bristles.

A toothbrush Al which is manually operable in use comprises a grip handle 1, a crown cap 2, and bristle assemblies 3, 3a.

The grip handle 1 is in the form of a rod of plastic and has an engaging body 10 as a mounting means on its distal end. The engaging body 10 comprises a pair of juxtaposed flexible members 11 spaced from each other and each composed of an engaging member having a curved outer side projecting outwardly.

The crown cap 2 comprises a member made of plastic and having a predetermined length, and has a substantially L-shaped cross section. The crown cap 2 has a vertical wing 21 for covering a tooth side and a horizontal wing 22 for covering an occlusal tooth area. The crown cap 2 has a pair of engaging holes 20 (one shown in FIG. 2) defined in the respective corners of longitudinal ends thereof, each of the engaging holes 20 serving as part of the mounting means for receiving the engaging body 10. The engaging body 10 can easily engage in and disengage from one of the engaging holes 20 with small forces, and can be fixed in position when engaging in one of the engaging holes 20.

The bristle assemblies 3, 3a are mounted on respective inner surfaces of the vertical and horizontal wings 21, 22 of the crown cap 2. The bristle assemblies 3 on the vertical wing 21 are directly planted on the inner surface thereof such that their distal ends are inclined at an angle of substantially 45° toward the bent corner of the crown cap 2.

As shown in FIG. 2, the bristle assembly 3a on the horizontal wing 22 is mounted on its inner surface such that the projection of the bristle assembly 3a from the inner surface of the horizontal wing 22 can be adjusted in a certain range by an adjusting means. The adjusting means comprises a bristle base 30 in the form of an elongate rectangular plate.

The bristle base 30 is disposed in a rectangular guide hole 24 defined in the horizontal wing 22 for sliding movement into and out of the guide hole 24. An adjustment screw 25 threaded through a ceiling of the guide hole 24 has a tip end rotatably mounted in a central area of an inner wall of the bristle base 30. When the adjustment screw 25 is turned, the bristle base 30 slides into or out of the guide hole 24, thereby adjusting the projection of the bristle assembly 3a in a certain range.

As with the bristle assembly 3, the bristle assembly 3a is planted on the bristle base 30 such that their distal ends are inclined at an angle of substantially 45° toward the bent corner of the crown cap 2.

As shown in FIG. 3, the bristle assemblies 3, 3a have bristles 30 whose tip ends are bent toward the bent corner of the crown cap 2 and are rounded. The bristles 30 thus shaped are sufficiently effective to remove plague off teeth without damaging the gum when they brush the teeth.

A process of using the toothbrush according to this embodiment and operation thereof will be described below with reference to FIGS. 1 through 3.

(1) The length of tooth crowns which project from the gum varies from individual to individual. To use the toothbrush, the following adjustments are made in order to accommodate individuals' differences.

First, the tip end of the adjustable bristle assembly 3a is held against the occlusal tooth areas, and the projection of the bristle assembly 3a is adjusted by turning the adjustment screw 25 so that the other bristle assembly 3 abuts reliably against the boundaries (tooth necks) between the tooth sides and the gum.

(2) The tip end of the bristle assembly 3a is held against the occlusal tooth areas, and the tip end of the bristle assembly 3 is held against the tooth sides and the gum, followed by manual reciprocating swinging movement of the grip handle 1 about its own axis.

Though the bristle assemblies 3, 3a are angularly moved back and forth at this time, since the tip ends of the bristle assemblies 3, 3a are inclined toward the bent corner of the crown cap 2, the frictional force is stronger upon angular movement toward the bent corner of the crown cap 2, and weaker upon angular movement in the opposite direction. Therefore, plaque, tartar, and calculus deposited on the occlusal tooth areas, the tooth sides, and the tooth necks are gathered toward the bent corner of the crown cap 2 on its inner surface. For the same reason, the gum is not peeled off the tooth necks, and plaque, tartar, and calculus deposited on the tooth necks are removed without being pushed between the teeth and the gum.

(3) When the brushing of tooth regions which can be brushed in one direction by the crown cap 2 is finished, the crown cap 2 is removed from the grip handle 1, and the engaging body 2 of the grip handle 1 is caused to engage in the opposite engaging hole 20 of the crown cap 2. The vertical and horizontal wings 21, 22 of the crown cap 2 are now switched around, allowing the toothbrush to brush other tooth regions that have not been brushed.

Specifically, if the crown cap 2 and the grip handle 1 are assembled as shown in FIG. 1, then it is possible for the toothbrush to brush the outer surfaces of teeth on the lower jaw ranging from left back teeth to front teeth, and the inner surfaces of teeth on the lower jaw ranging from right back to front teeth, and also to brush the inner surfaces of teeth on the upper jaw ranging from left back to front teeth and the outer surfaces of teeth on the upper jaw ranging from right back to front teeth.

If the crown cap 2 is mounted in the opposite direction on the grip handle 1, then it is possible for the toothbrush to brush the outer surfaces of teeth on the lower jaw ranging from right back teeth to front teeth, and the inner surfaces of teeth on the lower jaw ranging from left back to front teeth, and also to brush the inner surfaces of teeth on the upper jaw ranging from right back to front teeth and the outer surfaces of teeth on the upper jaw ranging from left back to front teeth.

FIG. 4 is an exploded perspective view of an electric toothbrush according to the present invention.

An electric toothbrush A2 has a grip base 5 including a handle la on its distal end. The handle la can be actuated by a motor 51 housed as an electric actuator means in the grip base 5, to angularly move back and forth about its own axis through a converter mechanism 53. The converter mechanism 53 is of a known structure, and will not be described in detail.

In this embodiment, the handle la only moves angularly back and forth about its own axis. However, it is possible for the handle la to switch to back-and-forth sliding movement in the axial direction. A battery 52 is also housed in the grip base 5 and a switch 54 is mounted on the grip base 5.

The structure of the distal end of the handle la and the structures of a crown cap 2 and bristle assemblies 3, 3a mounted on the handle la are the same as those of the toothbrush A1 described above, and will not be described in detail. Those parts of the electric toothbrush A2 which are identical or equivalent to those of the toothbrush Al are denoted by identical reference numerals.

A method of using the electric toothbrush A2 and operation thereof are substantially the same as those of the toothbrush A1 except that the bristle assemblies 3, 3a are angularly moved back and forth by electric energy for higher efficiency.

FIG. 5 is a perspective view of a toothbrush according to another embodiment of the present invention.

A toothbrush A3 which is manually operable in use in the same manner as with the toothbrush A1. The toothbrush A3 is structurally different from the toothbrush A1 in that a grip handle 1 is fixed to an end of a crown cap 2a, and a bristle assembly 3a is directly planted on a horizontal wing 22 without the brush base 30, etc. used as adjusting means.

The structure of other portions of the toothbrush A3 is the same as that of the toothbrush A1, and will not be described in detail. Those parts of the toothbrush A3 which are identical or equivalent to those of the toothbrush A1 are denoted by identical reference numerals.

A process of using the toothbrush A3 and operation thereof are substantially the same as those of the toothbrush A1. However, the toothbrush A3 has no adjusting means for bristle assemblies unlike the toothbrush A1, and the projection of the bristle assemblies cannot be adjusted. Since the wings of the crown cap 2a are structurally identical to each other, the toothbrush A3 has no particular orientation, and can be used more conveniently as the crown cap 2a does not need to be changed in direction.

### [Brief description of the drawings]

[FIG. 1] is an exploded perspective view of a toothbrush according to an embodiment of the present invention;

[FIG. 2] is a view illustrative of the structure and operation of bristle assemblies of the toothbrush;

[FIG. 3] is an enlarged view of tip ends of bristles;

[FIG. 4] is an exploded perspective view of an electric toothbrush according to the present invention; and

[FIG. 5] is a perspective view of a toothbrush according to another embodiment of the present invention.

[Description of reference numerals]

| Al, A3 | toothbrush 1 |
|---|---|
| grip handle 10 | |
| engaging body 2 | |
| crown cap | |
| 20 | engaging hole |
| 21 | vertical wing |
| 22 | horizontal wing |
| 24 | guide hole |
| 25 | adjustment screw |
| 3, 3a | bristle assembly |
| 30 | brush base |
| A2 | electric toothbrush |
| la | handle |
| 5 | grip base |
| 51 | motor |

Fourth through seventh inventions will be described in detailed below based on embodiments shown in the drawings.

FIG. 6 is a perspective view of a toothbrush according to an embodiment of the present invention. FIG. 7 is a view illustrative of the structure of bristle assemblies and the manner which the bristle assemblies abut against tooth surface. FIG. 8 is an enlarged view of tip ends of bristles.

toothbrush A1 which is manually operable in use comprises a grip handle 1 and a crown cap 2. The grip handle 1 is in the form of a rod of plastic and the crown cap 2 is fixed to a distal end of the grip handle 1.

The crown cap 2 is molded of plastic and has a molar tooth fitting portion 21 having a substantially heart-shaped cross section and a front tooth fitting portion 22 having a substantially V-shaped cross section. The front tooth fitting portion 22 is of a curved shape such that its central region is slightly narrow as viewed in plan. The crown cap 2 has a round outer profile for protecting the inside of a mouth when in use.

A bristle assembly 3 is planted on the inner surface of the molar tooth fitting portion 21 substantially in its entirety such that the bristle assembly 3 are inclined at an angle of substantially 45° to surfaces of molar teeth to be fitted in the molar tooth fitting portion 21.

Furthermore, a bristle assembly 3a is planted on the inner surface of the front tooth fitting portion 22 substantially in its entirety such that the bristle assembly 3a are inclined at an angle of substantially 45° to surfaces of front teeth to be fitted in the front tooth fitting portion 22.

As shown in FIG. 8, the bristle assemblies 3, 3a have bristles 30 whose tip ends are bent toward the bent corner of the crown cap 2 and are rounded. The bristles 30 thus shaped are sufficiently effective to remove plague off teeth without damaging the gum when they brush the teeth.

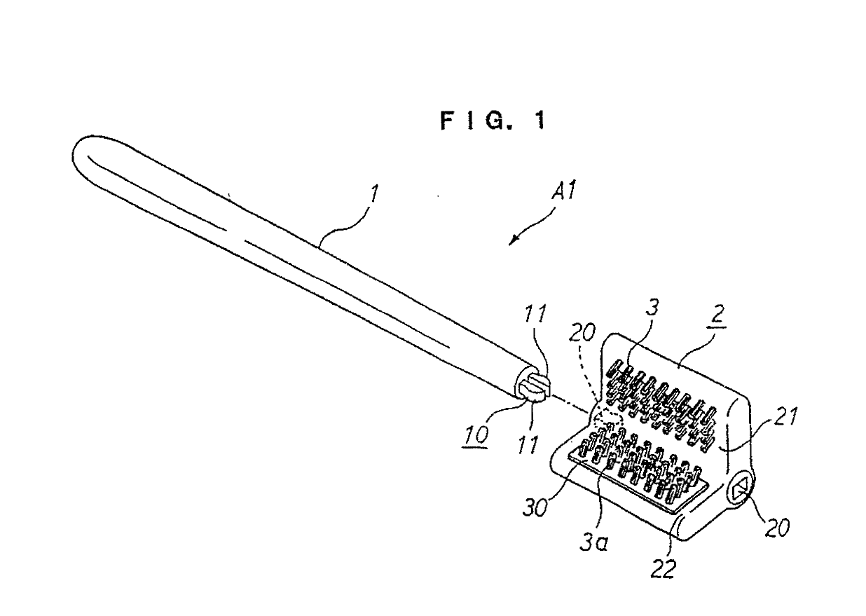

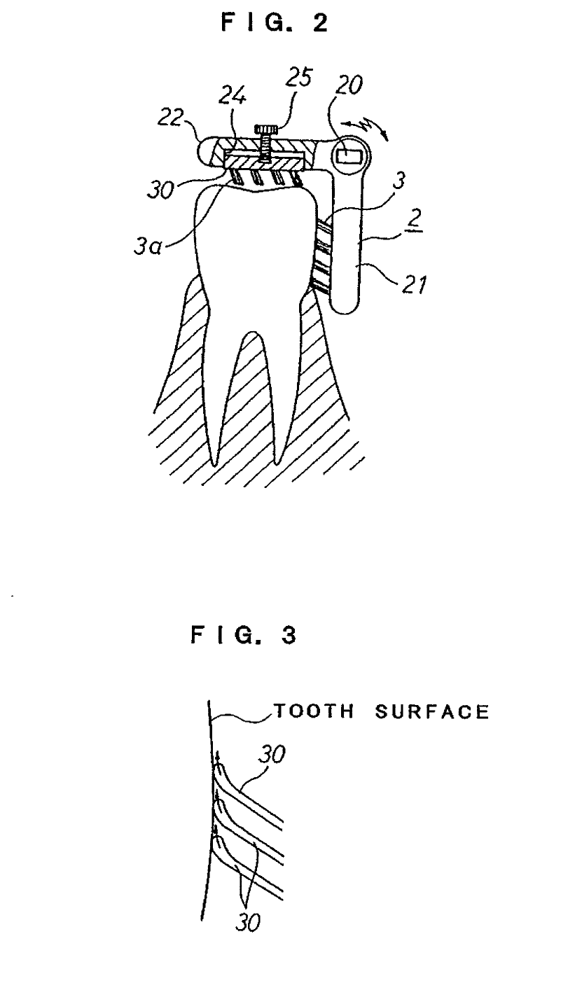

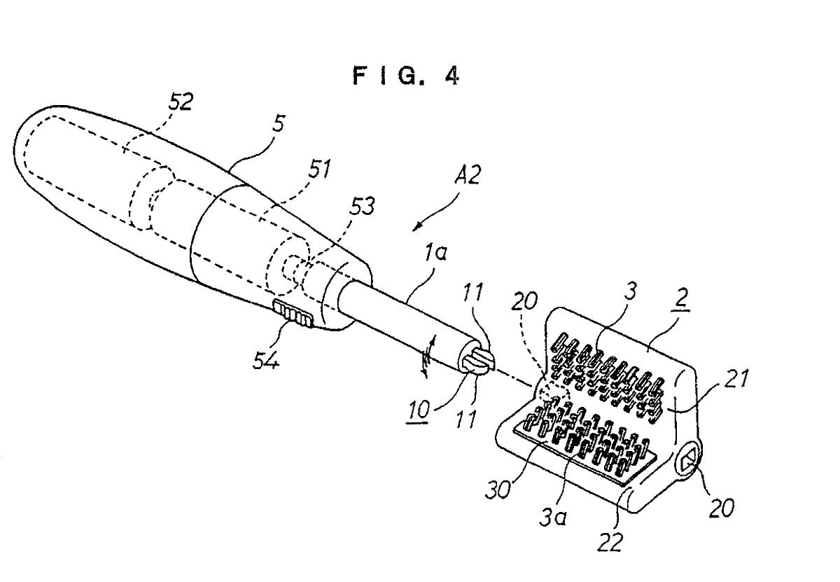

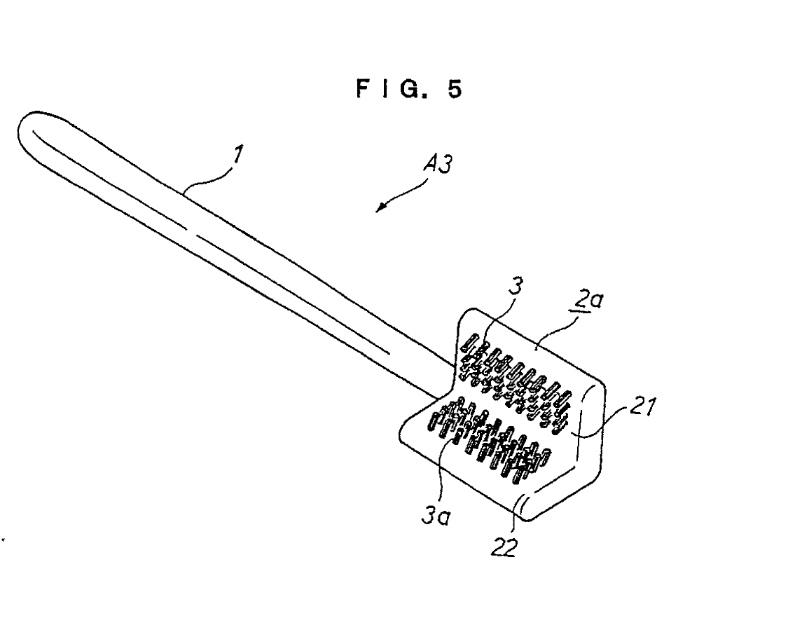

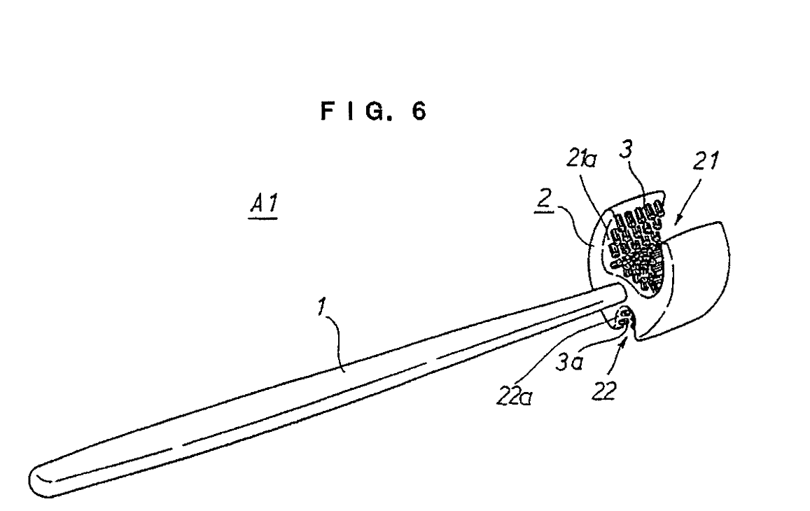

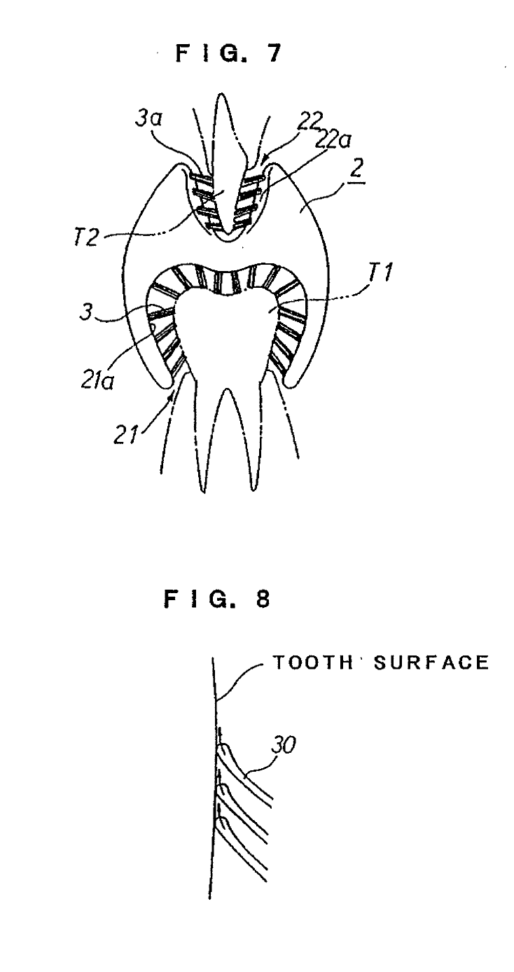

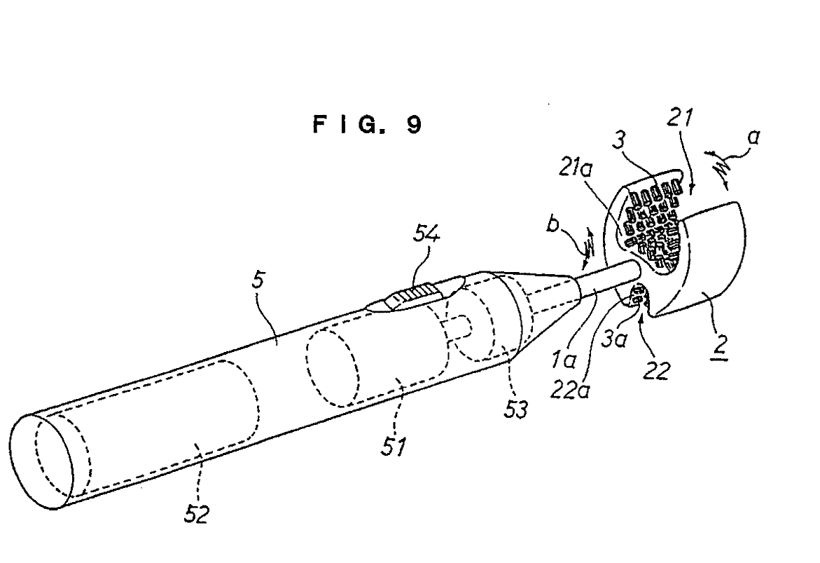

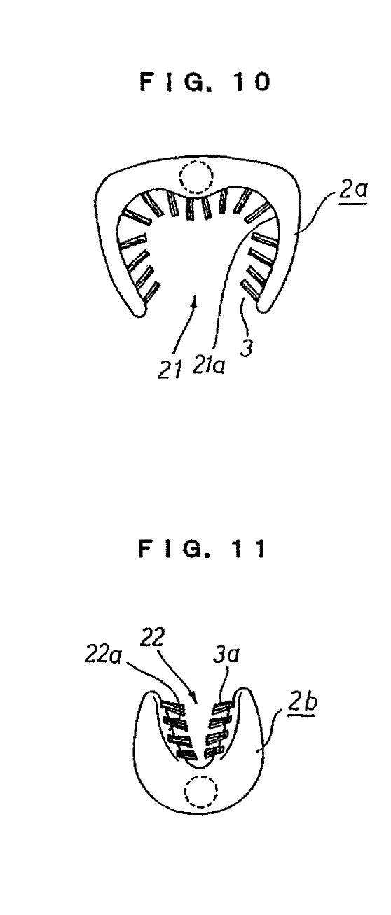

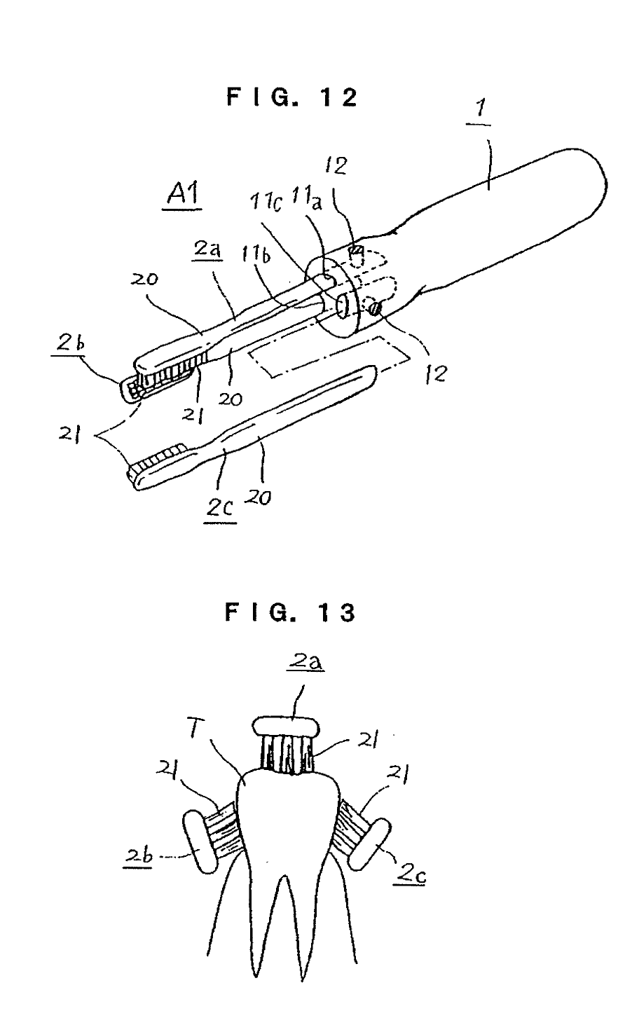

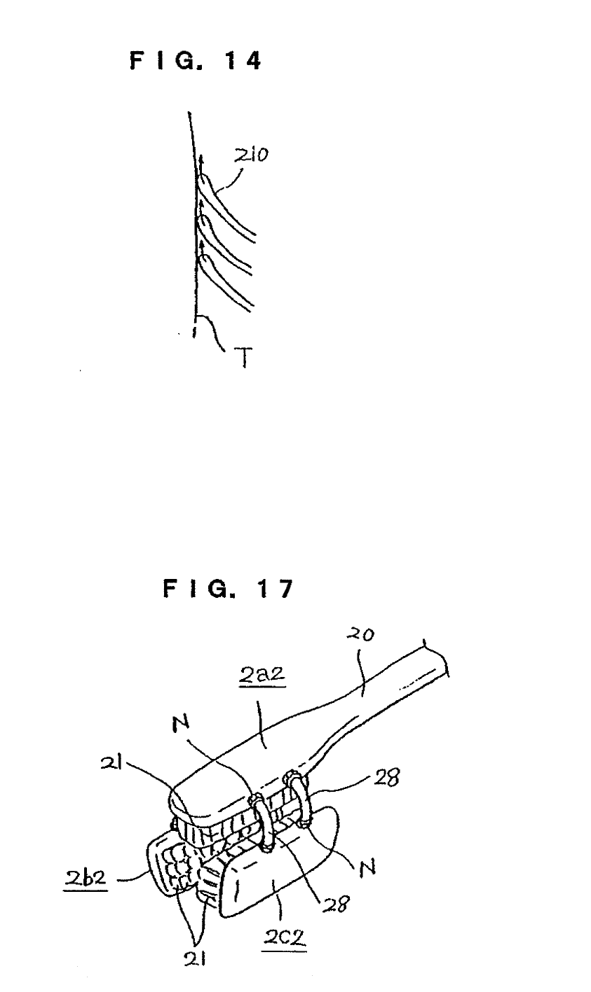

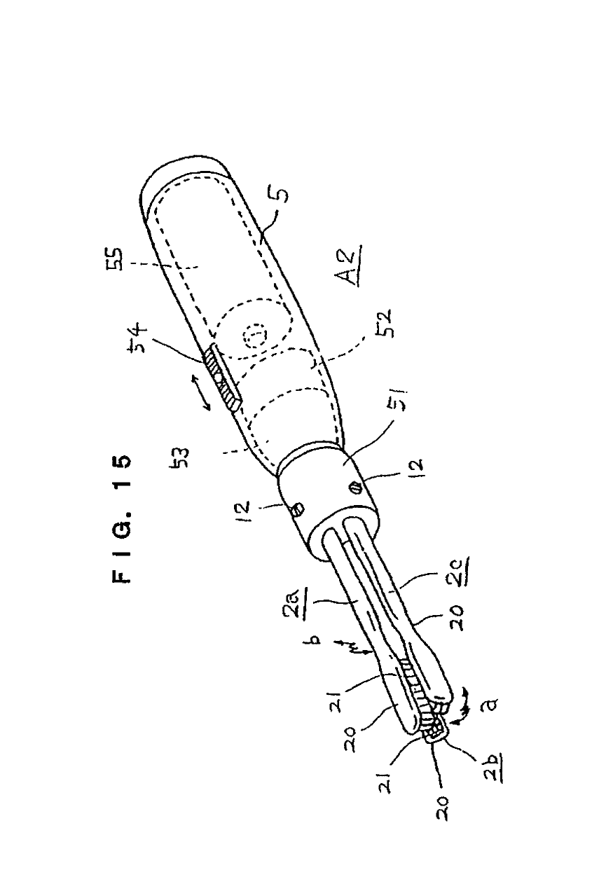

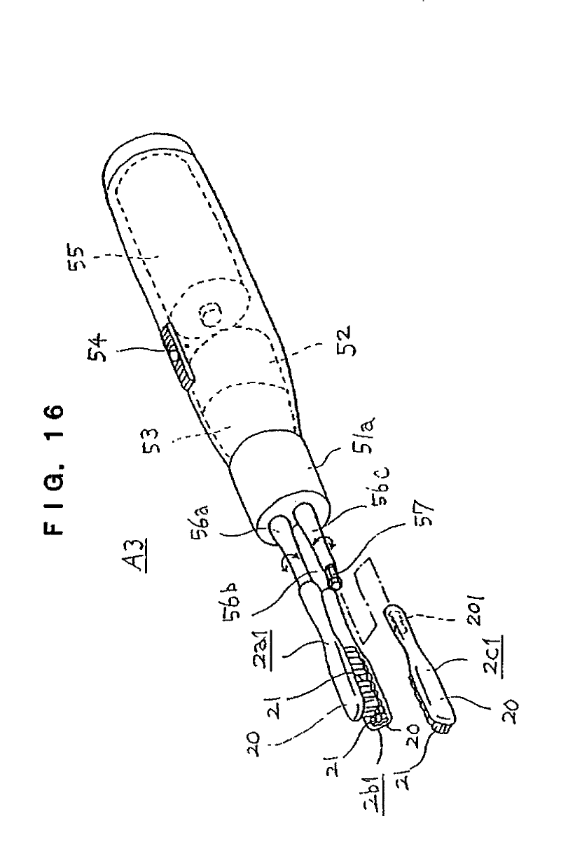

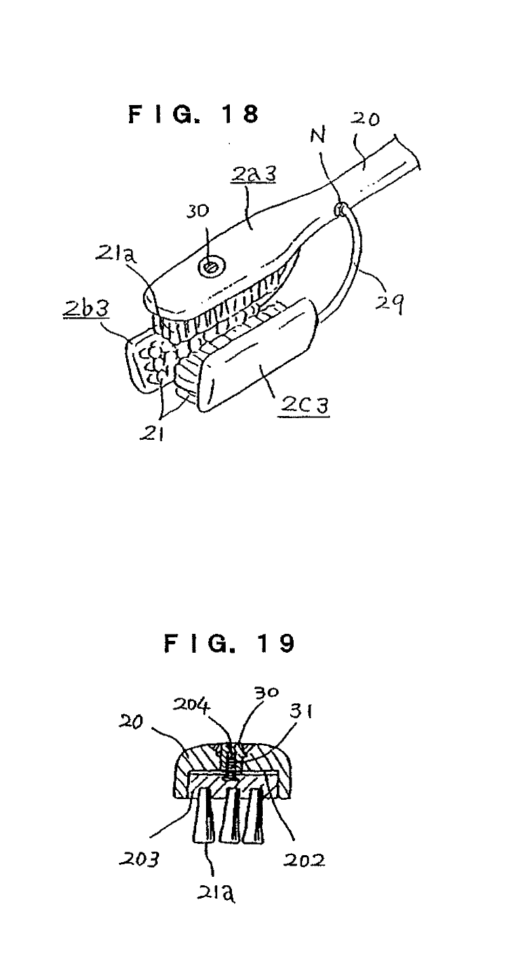

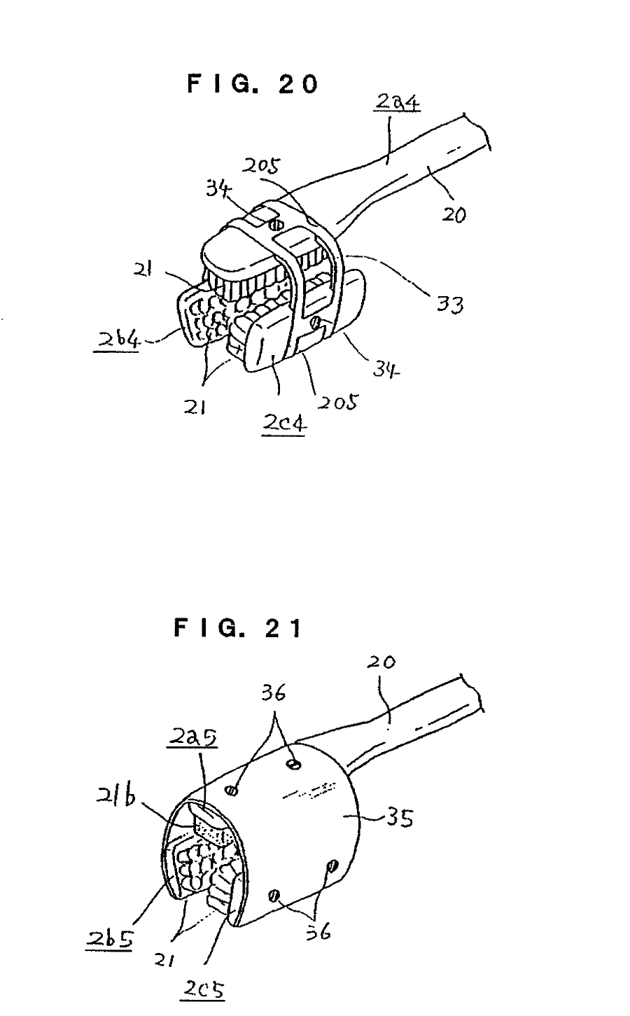

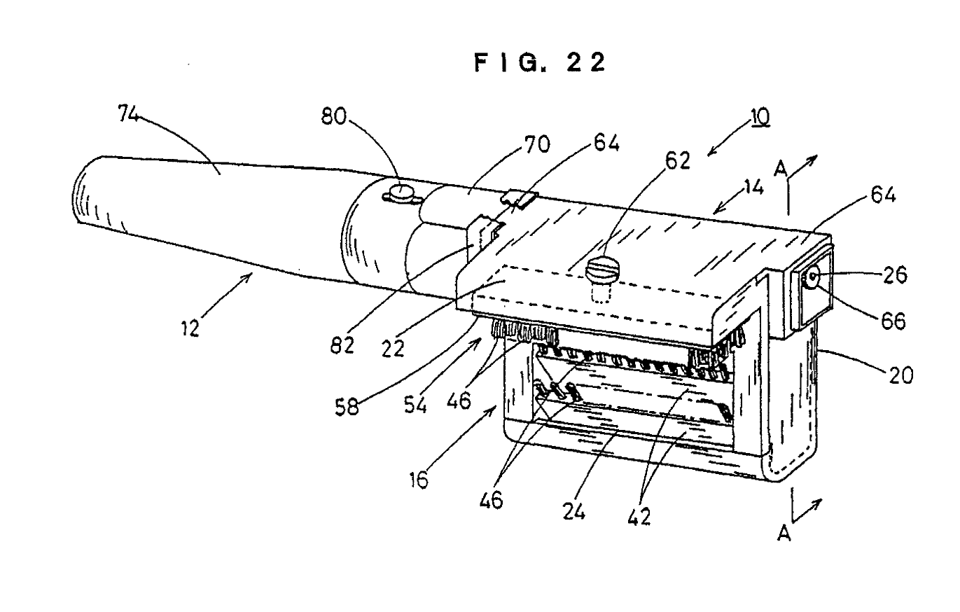

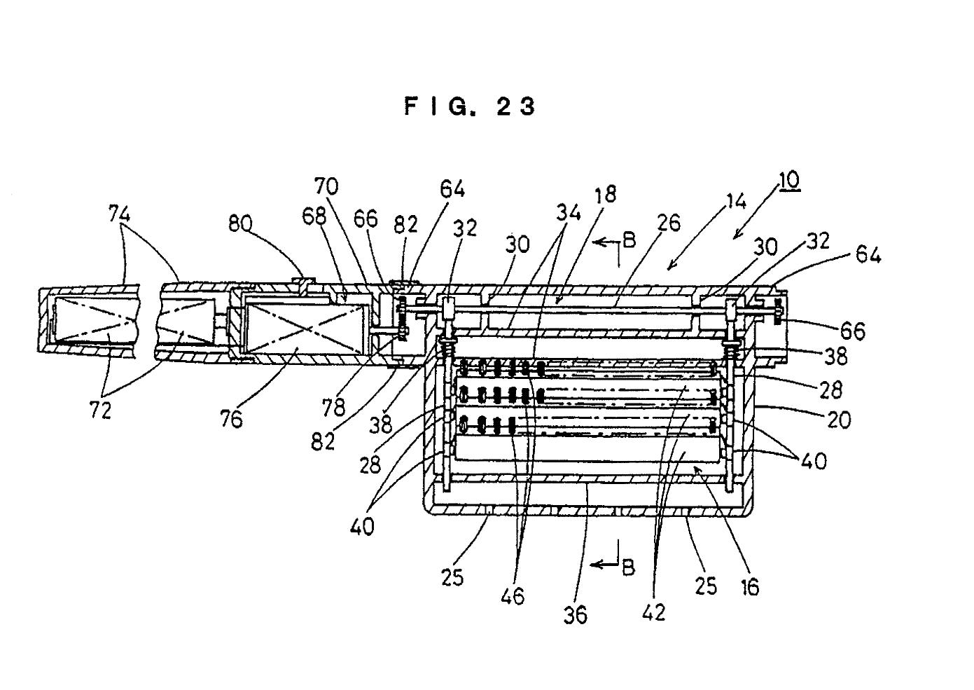

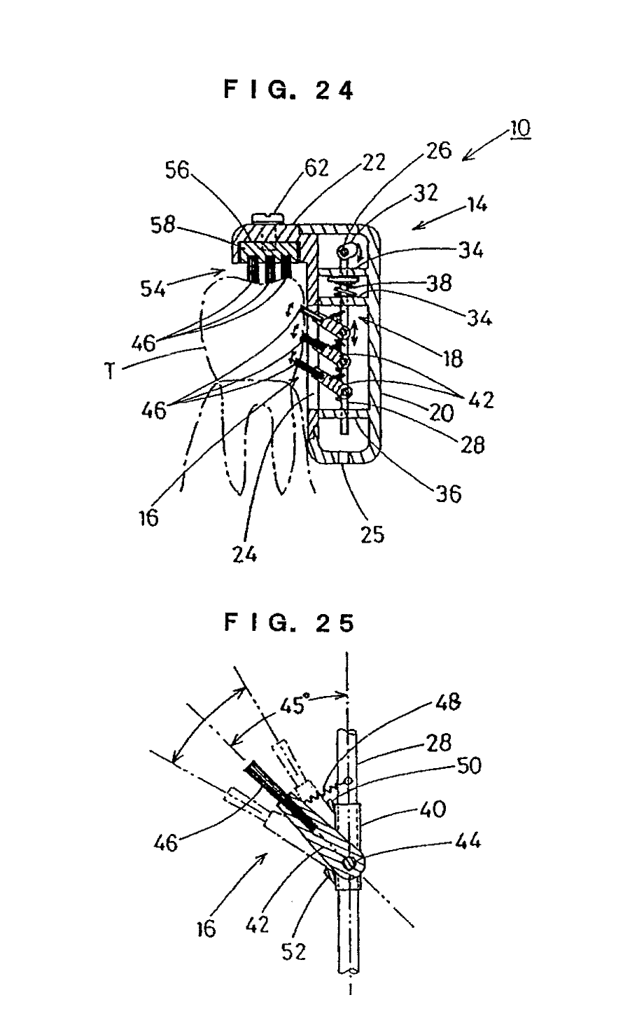

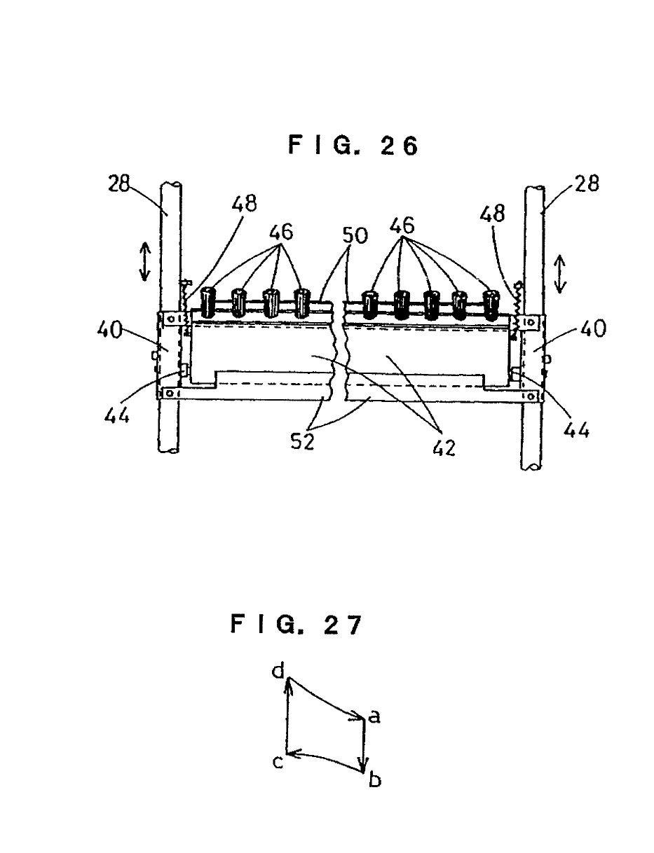

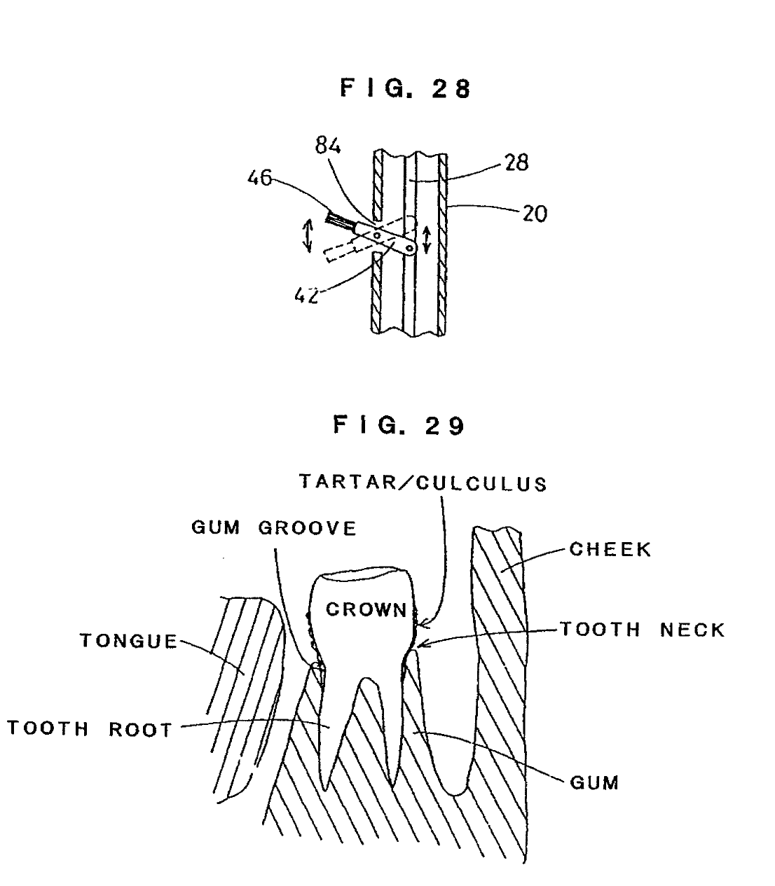

A process of using the toothbrush according to this embodiment and operation thereof will be described below with reference to FIGS. 6 through 8.

(1) The molar tooth fitting portion 21 is fitted over a molar tooth Tl and the bristle assembly 3 are directed substantially at 45° with respect to surfaces of the molar tooth Tl. Then, the grip handle 1 is manually angularly moved back and forth around its own axis or in the direction of the tooth axis or the direction normal thereto for thereby brushing the molar tooth Tl.

Though the bristle assemblies 3, 3a are angularly moved back and forth at this time, since the bristle assemblies 3, 3a are inclined to the tooth surfaces, the fric-tional force is stronger upon movement toward the tip end of the tooth, and weaker upon movement in the opposite direction. Therefore, plague, tartar, and calculus deposited on the occlusal tooth area, the tooth sides, and the tooth neck of the molar tooth Tl are gathered toward the center of the molar tooth fitting portion 21. For the same reason, the gum is not peeled off the tooth neck, and plaque, tartar, and calculus deposited on the tooth neck are removed without being pushed between the tooth and the gum.

(2) When the brushing of the molar tooth Tl is finished, the front tooth fitting portion 22 is fitted over a front tooth T2. Upon brushing the front tooth T2 in the same manner as with the molar tooth Tl, plaque, tartar, and calculus are gathered toward the center of the front tooth fitting portion 22, and removed without being pushed between the tooth and the gum.

FIG. 9 is a perspective view of an electric toothbrush according to the present invention.

An electric toothbrush A2 has a grip base 5 including a handle la on its distal end.

The handle la can be actuated by a motor 51 housed as an electric actuator means in the grip base 5, to angularly move back and forth about its own axis (as indicated by the arrows “a”) and in the direction of the tooth axis (as indicated by arrows “b ”) through a converter mechanism 53. The converter mechanism 53 is of a known structure, and will not be described in detail.

In this embodiment, it is possible for the handle la to switch in its movement between the direction around its own axis, the direction of the tooth axis, and the direction normal thereto with a selector switch (not shown). A battery 52 is also housed in the grip base 5 and a switch 54 is mounted on the grip base 5.

The structures of a crown cap 2 and bristle assemblies 3, 3a fixed to the distal end of the handle la are the same as those of the toothbrush A1 described above, and will not be described in detail. Those parts of the electric toothbrush A2 which are identical or equivalent to those of the toothbrush A1 are denoted by identical reference numerals.

A method of using the electric toothbrush A2 and operation thereof are substantially the same as those of the toothbrush A1 except that the bristle assemblies 3, 3a are angularly moved back and forth by electric energy for higher efficiency.

FIGS. 10 and 11 are front elevational views showing other structures of crown caps.

A crown cap 2a shown in FIG. 10 is of a structure having a molar tooth fitting portion 21 and bristle assembly 3 only, and is used solely for brushing molar teeth.

A crown cap 2b shown in FIG. 11 is of a structure having a front tooth fitting portion 22 and bristle assembly 3a only, and is used solely for brushing front teeth.

Those parts of the crown caps 2a, 2b shown in FIGS. 10 and 11 which are identical or equivalent to those of the crown cap 2 are indicated by identical reference numerals.

While the crown caps 2a, 2b operate substantially in the same manner as the crown cap 2 according to the above embodiment, the crown caps 2a, 2b are simpler in structure and smaller in size, and hence can be moved easily in the mouth.

### [Brief description of the drawings]

[FIG. 6] is a perspective view of a toothbrush according to an embodiment of the present invention;

[FIG. 7] is a view illustrative of the structure of bristle assemblies and the manner in which the bristle assemblies abut against tooth surfaces;

[FIG. 8] is an enlarged view of tip ends of bristles;

[FIG. 9] is a perspective view of an electric toothbrush according to the present invention;

[FIG. 10] is a front elevational view of the structure of another crown cap; and

[FIG. 11] is a front elevational view of the structure of still another crown cap.

### [Description of reference numerals]

| Al | toothbrush |
|---|---|
| 1 | grip handle |
| 2. 2a, 2b | crown cap |
| 3. 3a | bristle assembly |
| A2 | electric toothbrush |
| la | handle |
| 5 | grip base |
| 51 | motor |

Eighteenth and nineteenth inventions will be described in detail below based on embodiments shown in the drawings.

FIG. 12 is an exploded perspective view of a toothbrush according to an embodiment of the present invention. FIG. 13 is a view illustrative of the structure of bristle assemblies and the manner in which the bristle assemblies abut against tooth surfaces. FIG. 14 is an enlarged view of tip ends of bristles.

A toothbrush A1 which is manually operable in use comprises a grip handle 1 and three toothbrush bodies 2a, 2b, 2c. The grip handle I is in the form of a rod of plastic and the toothbrush bodies 2a, 2b, 2c are detachably mounted on a distal end of the grip handle 1.

Each of the toothbrush bodies 2a, 2b, 2c has a handle 20 with bristle assemblies 21 mounted on its distal end portion which as a round profile for protecting the inside the mouth from damage during use.

The structure by which the toothbrush bodies 2a, 2b, 2c are attached to the grip handle 1 will be described below. The distal end of the grip handle 1 has three fixing holes lla, lib, lie defined therein and three threaded holes also defined therein between the fixing holes lla, lib, lie and an outer surface of the grip handle 1. Fastening screws 12 are threaded in the respective threaded holes. When the fastening screws 12 are tightened, the respective ends of the handles 20 of the toothbrush bodies 2a, 2b, 2c that are received in the fixing holes lla, lib, lie are secured therein.

The fixing holes lla, lib, lie have a substantially elliptical cross section similar to that of the handles 20, so that when the handles are inserted into the respective fixing holes lla, lib, lie, the angles of the toothbrush bodies 2a, 2b, 2c about their own axes are automatically set.

The angles to which the toothbrush bodies 2a, 2b, 2c are set will be described below with reference to FIG. 13.

The toothbrush body 2a corresponds to the occlusal tooth area of a tooth, and its bristle assemblies 21 abut against the occlusal tooth area substantially perpendicularly thereto. The toothbrush bodies 2b, 2c correspond respectively to the opposite sides of the tooth. The bristle assemblies 21 of the toothbrush bodies 2b, 2c are inclined at an angle of substantially 45° to the tooth sides toward the tip end of the tooth which is to be fitted in a region surrounded by these bristle assemblies 21.

As shown in FIG. 14, the bristle assemblies 21 have bristle fibers 210 whose tip ends are bent toward the tip end of a tooth and are rounded. The bristle fibers 210 thus shaped are sufficiently effective to remove plague off teeth without damaging the gum when they brush the teeth.

A process of using the toothbrush according to this embodiment and operation thereof will be described below with reference to FIG. 12 through 14.

A tooth T is fitted into the space surrounded by the bristle assemblies 21, and the bristle assemblies 21 corresponding to tooth sides Tl are directed substantially at 45° with respect to the tooth sides Tl. Then, the grip handle 1 is manually vibrated around its own axis or in the direction of the tooth axis or the direction normal thereto for thereby brushing the tooth.

Though the bristle assemblies 21 are vibrated at this time, since the bristle assemblies 21 are inclined to the tooth sides Tl, the frictional force is stronger upon movement toward the tip end of the tooth, and weaker upon movement toward the roots of the tooth. Therefore, plague, tartar, and calculus deposited on the occlusal tooth area, the tooth sides, and the tooth neck of the tooth are gathered toward the center of the tip end of the tooth. For the same reason, even when rubbed by the bristle assemblies 21, the gum is not peeled off the tooth neck, and plaque, tartar, and calculus deposited on the tooth neck are removed without being pushed between the tooth and the gum.

FIG. 15 is a perspective view of an electric toothbrush according to the present invention.

An electric toothbrush A2 has a grip base 5 including an attachment 51 on its distal end. To the attachment 51, there are attached three toothbrush bodies 2a, 2b, 2c as with the toothbrush A1.

The attachment 51 can be actuated by a motor 51 housed as an electric actuator means in the grip base 5, to angularly move back and forth about its own axis (as indicated by the arrows “a”) and in the direction of the tooth axis (as indicated by arrows “b”) through a converter mechanism 53. The converter mechanism 53 is of a known structure, and will not be described in detail.

In this embodiment, it is possible for the attachment 51 (handle 20) to switch in its movement between the direction around its own axis and the direction of the tooth axis with a selector switch 54. In addition, the attachment 51 may be vibrated in the direction normal too the direction of the tooth axis ( i. e., vibrated in the direction in which the attachment 51 moves into and out of the mouth). A battery 55 is housed in the grip base 5.

Those parts of the electric toothbrush A2 which are identical or equivalent to those of the toothbrush A1 are denoted by identical reference numerals.

A method of using the electric toothbrush A2 and operation thereof are substantially the same as those of the toothbrush A1 except that the toothbrush bodies 2a, 2b, Ic (the bristle assemblies 21) are vibrated by electric energy for higher efficiency.

FIG. 16 is an exploded perspective view of an electric toothbrush according to another embodiment of the present invention.

An electric toothbrush A3 has three handles 56a, 56b, 56c mounted on an attachment 51a. The handles 56a, 56b, 56c can be vibrated about their own axes independently by a converter mechanism 53. The handles 56a, 56b, 56c have respective fitting portions 57 of square-shaped cross section on their distal ends.

Toothbrush bodies 2al, 2bl, 2cl are detachably mounted on the respective fitting portions 57. The toothbrush bodies 2al, 2bl, 2cl include respective handles 20 which have in their proximal ends respective fitting holes 201 that receive the respective fitting portions 57 fitted therein. The fitting portions 57 can detachably be fitted in the fitting holes 201 by known means in one operation.

The angles at which the toothbrush bodies 2al, 2bl, 2cl are attached around the axis of the toothbrush are set in the same manner as with the above embodiments.

Those parts of the electric toothbrush A3 which are identical or equivalent to those of the electric toothbrush A2 are indicated by identical reference numerals.

A method of using the electric toothbrush A3 and operation thereof are essentially the same as with the electric toothbrush A2 except that the toothbrush bodies 2al, 2bl, 2cl can be detached and attached with ease and the toothbrush bodies 2al, 2bl, 2cl (the bristle assemblies 21) can be vibrated about their respective axes by electric energy.

FIG. 17 is a fragmentary perspective view of toothbrush bodies according to a second embodiment of the present invention.

In this embodiment, only a toothbrush body 2a2 has a handle 20, and toothbrush bodies 2b2, 2c2 which are of substantially the same extent as bristle assemblies are attached to the toothbrush body 2a2 by curved arm pins 28 of stainless steel that are disposed on opposite sides of the toothbrush body 2a2. The arm pins 28 are secured in position by nuts N that are tightened. When loosened, the nuts N allow only the toothbrush bodies 2b2, 2c2 to be replaced.

The angles at which the toothbrush bodies 2a2, 2b2, 2c2 are attached around the axis of the toothbrush are set in the same manner as with the above embodiments.

FIG. 18 is a fragmentary perspective view of toothbrush bodies according to a third embodiment of the present invention, and FIG. 19 is a cross-sectional view of one of the toothbrush bodies according to the third embodiment.

In this embodiment, toothbrush bodies 2b3, 2c3 are attached to a toothbrush body 2a3 by arm pins 29 extending from the neck of a handle 20 of the toothbrush body 2a3.

As shown in FIG. 19, an adjustment screw 30 is undetachably rotatably mounted on an upper surface of the handle 20 near its distal end. The adjustment screw 30 has a threaded hole 31 defined in its lower portion.

The handle 20 has a recess 202 defined in a lower portion thereof near its distal end and housing a vertically movable body 203. A screw 204 is vertically fixed to an upper surface of the vertically movable body 203, and threaded in the threaded hole 204. A bristle assembly 21a is mounted on a lower surface of the vertically movable body 203.

When the adjustment screw 30 is turned, the vertically movable body 203 is vertically moved to adjust the height of the bristle assemblies 21 of the toothbrush bodies 2b3, 2c3 for use.

The angles at which the toothbrush bodies 2a3, 2b3, 2c3 are attached around the axis of the toothbrush are set in the same manner as with the above embodiments.

FIG. 20 is a fragmentary perspective view of toothbrush bodies according to a fourth embodiment of the present invention.

In this embodiment, toothbrush bodies 2a4, 2b4, 2c4 have fitting grooves 205 defined in their respective outer surfaces, and joints 33 of stainless steel having a channel shape in front elevation are fitted in the fitting grooves 205. The joints 33 are secured in position to the toothbrush bodies 2a4, 2b4, 2c4, thus integrally joining the toothbrush bodies 2a4, 2b4, 2c4 to each other.

The angles at which the toothbrush bodies 2a4, 2b4, 2c4 are attached around the axis of the toothbrush are set in the same manner as with the above embodiments.

FIG. 21 is a fragmentary perspective view of toothbrush bodies according to a fifth embodiment of the present invention.

In this embodiment, toothbrush bodies 2a5, 2b5, 2c5 are integrally joined to each other by a curved enclosing plate 35 of stainless steel which is fastened to them by screws 36. A cushion 21b made of hard sponge, rather than bristle assembly, is attached to a lower surface of the toothbrush body 2a5.

Those parts of the toothbrushes shown in FIGS. 17 through 21 which are identical or equivalent to those of the aforesaid embodiments are indicated by identical reference numerals.

### [Brief description of the drawings]

[FIG. 12] is an exploded perspective view of a toothbrush according to an embodiment of the present invention;

[FIG. 13] is a view illustrative of the structure of bristle assemblies and the manner in which the bristle assemblies abut against tooth surfaces;

[FIG. 14] is an enlarged view of tip ends of bristies;

[FIG. 15] is a perspective view of an electric toothbrush according to the present invention;

[FIG. 16] is an exploded perspective view of an electric toothbrush according to another embodiment of the present invention;

[FIG. 17] is a fragmentary perspective view of toothbrush bodies according to a second embodiment of the present invention;

[FIG. 18] is a fragmentary perspective view of toothbrush bodies according to a third embodiment of the present invention;

[FIG. 19] is a cross-sectional view of one of the toothbrush bodies according to the third embodiment of the present invention;

[FIG. 20] is a fragmentary perspective view of toothbrush bodies according to a fourth embodiment of the present invention; and

[FIG. 21] is a fragmentary perspective view of toothbrush bodies according to a fifth embodiment of the present invention.

### [Description of reference numerals]

| Al | toothbrush |
|---|---|
| 1 | grip handle |
| 2a, 2b, 2c | toothbrush body |
| 20 | handle |
| 21 | bristle assemblies |
| lla, lib, lie | fixing hole |
| 12 | fastening screw |
| A2 | Electric toothbrush 55 |
| battery 5 | grip base |
| 51 | attachment |
| 52 | motor |
| 53 | converter mechanism |

Preferred embodiments of tenth through sixteenth inventions will be described below.

FIGS. 22, 23, and 24 show an electric toothbrush 10 according to an embodiment of the present invention.

As shown in FIGS. 22, 23, and 24, the electric toothbrush 10 has a casing 14 with a handle 12 projecting from one end therof. The casing 14 houses a bristle assembly 16 reciprocally angularly movable to swing upwardly along teeth sides while being held against the teeth sides or neighboring regions, and a reciprocally rocking mechanism 18 for reciprocally angularly moving the bristle assembly 16.

As shown in FIGS. 22 and 23, the casing 14 comprises a vertical case 20 on one side and a horizontal case 22 on another side, the cases 20, 22 being joined in an inverted L shape as viewed in end elevation. The horizontal case 22 is joined to the vertical case 20 so as to project from an upper end of the vertical case 20.

The vertical case 20 and the horizontal case 22 are made of a hard synthetic resin or the like. The vertical case 20 has a hole 24 defined in an inner side wall thereof for placing the bristle assembly 16 therein, and a drain hole 25 defined in a bottom wall thereof for draining water out of the casing 14.

As shown in FIGS. 23 and 24, the reciprocally rocking mechanism 18 has a rotatable shaft 26 journaled in an upper position in the vertical case 20, and a pair of swing shafts 28 disposed vertically in the vertical case 20 at respective positions near the ends of the vertical case 20.

The rotatable shaft 26 is rotatably supported by a pair of bearings 30 disposed in the upper position in the vertical case 20. A pair of plate cams 32 is fixedly mounted on the rotatable shaft 26 near its opposite ends and held in sliding contact with the respective upper ends of the swing shafts 28.

The swing shafts 28 are journaled in shaft holes that are defined in two upper bearing plates 34 horizontally disposed in the upper position in the vertical case 20, and shaft holes that are defined in a lower bearing plate 36 horizontally disposed in a lower position in the vertical case 20. Coil springs 38 are mounted on the swing shafts 28, respectively, between the upper bearing plates 34 for normally urging the swing shafts 28 to move upwardly. Pivot supports 40 by which the bristle assembly 16 are pivotally supported are fixedly mounted in upper and lower regions on the swing shafts 28 between the upper and lower bearing plates 34, 36.

When the rotatable shaft 26 of the reciprocally rocking mechanism 18 is rotated, the swing shafts 28 are lowered against the bias of the coil springs 38 each time cam lobes of the plate cams 32 make one revolution, and hence are reciprocally moved in the vertical direction. The reciprocally rocking mechanism 18 is not limited to the rotating plate cams 32, but crank mechanisms or the like may be combined with the rotatable shaft 26 for vertically moving the swing shafts 28 in interlinked relation thereto.

As shown in FIGS. 24, 25, and 26, the bristle assembly 16 have two or three bristle bases 42 positioned in upper and lower positions between the swing shafts 28 of the reciprocally rocking mechanism 18 and extending obliquely upwardly toward the hole 24 defined in the inner side wall of the vertical case 20. Each of the bristle bases 42 is of a flat shape elongate in the horizontal direction and has a support shaft 44 extending longitudinally through and fixed to a lower end thereof. Bristles 46 are planted on an upper end of each of the bristle bases 42.

The bristle bases 42 are pivotally supported by opposite ends of the support shafts 44 on the pivot supports 40 that are fitted over the swing shafts 28 in their upper and lower regions. Resilient members 48 such as coil springs are connected between the opposite ends of the bristle bases 42 and the swing shafts 28. The bristle bases 42 project obliquely upwardly from within the vertical case 20 toward the hole 24 in the inner side wall thereof.

As shown in FIGS. 25 and 26, each of the bristle bases 42 is inclined upwardly at an angle of about 45° from its pivots on the swing shafts 28. Upper and lower stoppers 50, 52 are horizontally mounted on the pivot supports 40 on the swing shafts 28 such that the bristle base 42 can swing vertically in an upward angle of about 15° from the inclined position and in a downward angle of about 15° from the inclined position.

When the bristles 46 on the bristle bases 42 abut against a tooth side and the swing shafts 28 are lowered, the bristle bases 42 are turned upwardly and hence closed until they are engaged by the upper stoppers 50 while being lowered. When the swing shaft 28 are lifted, the bristle bases 42 are spread and received by the lower stoppers 52 while being elevated. On their way upward, the bristle bases 42 are closed under the bias of the resilient members 48 and return to their original position.

At this time, the tip ends of the bristles 46 are reciprocally angularly moved upwardly in coaction with the swing shafts 28 along paths as shown in FIG. 27, i.e., a path a-b where the ends of the bristles 46 are lowered and substantially held against a tooth neck, a path b-c where the ends of the bristles 46 abut against the tooth neck and the bristles 46 are spread, a path c-d where the ends of the bristles 46 brush a tooth side upwardly in a scraping manner and move upwardly while being spread, and a path d-a where the ends of the bristles 46 are closed).

Since the bristles 46 are closed as they are lowered, they do not peel off the end of the gum. When the bristles 46 are elevated, they can scrape plaque deposited on the tooth neck and tooth side.

In the embodiment shown in FIGS. 23 and 24, the bristle bases 42 are disposed in upper, middle, and lower positions. The bristles 46 on the bristle bases 42 are longer, shorter, and medium successively from the lower position through the middle position to the upper position. With this arrangement, the bristles 46 of the bristle assembly 16 can be brought into abutment against a curved tooth surface extending from the tooth side along the tooth neck for scraping off deposited plaque.

The bristle bases 42 may be located in upper and lower positions. In this case, the bristles 46 on the bristle base 42 in the lower position should preferably be longer than the bristles 46 on the bristle base 42 in the upper position for abutment against the curved tooth surface extending from the tooth side along the tooth neck for scraping off deposited plaque.

The bristles 46 may be planted through a coupling on the bristle bases 42 so that the bristles 46 can be replaced.

As shown in FIGS. 22 and 24, a temporary positioning member 54 for temporarily positioning the bristles 46 of the bristle assembly 16 for engagement with the tooth side and the tooth neck is mounted on the horizontal case 22 of the casing 14.

The temporary positioning member 54 has a base plate 58 fitted in a recess 22 that is defined in a lower surface of the horizontal case 22, and bristles 46 planted on a lower surface of the base plate 58. Instead of the bristles 46, a resilient member such as of sponge may be fixed in place to the base plate 58.

An adjustment screw 62 threaded through a threaded hole 60 defined in the horizontal case 22 has a lower end loosely engaging the base plate 58 that is fitted in the recess 56. When the adjustment screw 62 is turned in one direction or the other, the base plate 58 is vertically slid in the recess 56 for thereby adjusting the height of the bristles 46.

When the bristles 46 of the temporary positioning member 54 is held in abutment against the occlusal area of the crown of a tooth, the bristles 46 of the bristle assembly 16 that project from the inner side wall of the vertical case 20 are accurately brought into abutment against the tooth side and the tooth neck, allowing the bristle assembly 16 to brush the tooth upon reciprocating angular movement.

As shown in FIGS. 22 and 23, the casing 14 has joint sleeves 64 extending from upper portions of its opposite ends for detachably joining 12 handle 12. In the joint sleeves 64, there are disposed respective gears 66 fixed to respective opposite ends of the rotatable shaft 26 of the reciprocally rocking mechanism 18 which project into the joint sleeves 64.

The handle 12 comprises a cylindrical body 70 detachably joined to one of the joint sleeves 64 and housing an actuator 68, and a grip cylinder 74 detachably joined to the cylindrical body 70 and housing a battery 72 or a booster or the like for converting AC electric energy into DC electric energy.

The actuator 68 comprises a small motor 76 having a rotatable shaft to which a gear 78 is fixed, and a gear 66 fixed to the rotatable shaft 26 in the joint sleeve 64 is held in mesh with the gear 78. When a switch 80 mounted on an upper surface of the cylindrical body 70 is turned on, the small motor 76 is energized to actuate the reciprocally rocking mechanism 18 in the casing 14. The joined ends of the joint sleeve 64 and the cylindrical body 70 should preferably be reinforced by a reinforcing band 82 mounted thereon.

The electric toothbrush 10 according to the present invention is used as follows. While the user is gripping the handle 12, the user holds the temporary positioning member 54 against the occlusal area of the crown of a tooth T for thereby positioning the tip ends of the bristles 46 of the bristle assembly 16 in abutment against the tooth side to the tooth neck of the tooth T, as shown in FIG. 24.

Then, the user turns on the switch 80 on the handle 12 to cause the small motor 76 of the actuator 68 to rotate the rotatable shaft 26 in the casing 14. The swing shafts 28 of the reciprocally rocking mechanism 18 are moved vertically, causing the bristle bases 42 of the bristle assembly 16 coupled to the swing shafts 28 to angularly move reciprocally.

The tip ends of the bristles 46 are angularly moved reciprocally in a manner to turn upwardly to scrape off plaque deposited on the tooth side and the tooth neck without pushing the plaque into a gum groove. The bristles 46 are also effective to massage the gum. The temporary positioning member 54 of the casing 14 is moved along the occlusal areas of upper and lower teeth in abutment thereagainst for thereby removing plaque deposited on the tooth side and the tooth neck of each tooth T.

When the electric toothbrush 10 is to be used on the back of teeth T or the opposite side of the teeth, the cylindrical member 70 of the handle 12 is fitted over the joint sleeve 64 on the other end of the casing 14.

When the electric toothbrush 10 according to the present invention is used, therefore, the gum is prevented from being peeled off the tooth necks, and hence can be maintained in a healthy condition for protection against peri-odontites and dental caries.

As shown in FIG. 28, the lower end of each brush base 42 may be pivotally coupled to the swing shafts 28 in the vertical case 20 and the sides of each brush base 42 may be pivotally mounted in a lateral hole 84 defined in the inner side wall of the vertical case 20. When the swing shafts 28 are moved vertically, the brush base 42 is angularly moved to cause the bristles 46 on the end of the brush base 42 to remove plaque and tartar deposited on the tooth side and the tooth neck of each tooth T.

With the electric toothbrush 10 according to the present invention, the casing 14 may not necessarily be limited to an inverted L shape, but may be of a shape spreading at an obtuse angle. Furthermore, only the vertical case 20 may serve as a casing with the bristle assembly 16 housed therein. Such an arrangement is easier to use.

### [Brief description of the drawings]

[FIG. 22] is a perspective view of an electric toothbrush according to an embodiment of the present invention;

[FIG. 23] is a cross-sectional view taken along line A-A of FIG. 22;

[FIG. 24] is a cross-sectional view taken along line A-A of FIG. 23;

[FIG. 25] is an enlarged fragmentary vertical cross-sectional view of a bristle assembly;

[FIG. 26] is an enlarged fragmentary front elevational view of the bristle assembly;

[FIG. 27] is a diagram showing paths followed by the tip ends of bristles when the bristle assembly is angularly moved reciprocally;

[FIG. 28] is a fragmentary vertical cross-sectional view of a brush assembly according to another embodiment; and

[FIG. 29] is a view illustrative of the structure of a tooth.

### [Description of reference numerals]

| | | |
|---|---|---|
| 10 | electric toothbrush 14 | casing |
| 16 | bristle assembly 18 | |

reciprocally rocking mechanism; 46 bristle 54 temporarily positioning member 68 actuator [Advantages of the invention]

The present invention with the above arrangement offers the following advantages:

(a) The bristle assemblies of a toothbrush are inclined at a certain angle with respect to the sides of teeth toward the tip ends of the teeth that are fitted between the bristle assemblies. Therefore, when the teeth are fitted in the tooth fitting portion to bring the tip ends of the bristle assemblies into abutment against the teeth surfaces, and the bristle assemblies are angularly moved reciprocally, the frictional force applied by the bristle assemblies is stronger upon angular movement toward the tip ends of the teeth, and weaker upon angular movement in the opposite direction. Therefore, plaque, tartar, and calculus deposited on the occlusal tooth areas, the tooth sides, and the tooth necks are gathered toward the center of the tooth fitting portion by the bristle assemblies, and efficiently removed.

(b) As described above, when the bristle assemblies are angularly moved reciprocally, the frictional force applied by the bristle assemblies is stronger upon angular movement toward the tip ends of the teeth, and weaker upon angular movement in the opposite direction. Therefore, even when the tooth necks are brushed, the gum is not peeled off the tooth necks, and plaque, tartar, and calculus deposited on the tooth necks are not pushed between the teeth and the gum, and do not cause periodontites.

(c) The electric toothbrush can brush teeth more efficiently than the manually operable toothbrush because the bristle assemblies can be angularly moved reciprocally at higher speeds.

(d) With the toothbrush including the adjusting means, the projection of the bristle assembly can be adjusted by the adjusting means such that the bristle assembly adjustable by the adjusting means will abut against the occlusal tooth areas of teeth and the other bristle assemblies will abut reliably against the boundaries (the tooth necks) between the tooth sides and the gum. The toothbrush can thus accommodate various lengths, which differ from individual to individual, of teeth projecting from the gum, and is capable of brushing teeth effectively in a manner to suit the user.

(e) The electric toothbrushes according to the tenth through sixteenth inventions have a bristle assembly reciprocally angularly movable to swing upwardly along teeth sides while being held against the teeth sides or neighboring regions, a reciprocally rocking mechanism for reciprocally angularly moving the bristle assembly, and an actuator coupled to the reciprocally rocking mechanism. When the bristle assembly held against the tooth sides and the tooth necks are repeatedly turned upwardly, the gum is prevented from being peeled off the tooth necks, and hence can be maintained in a healthy condition. The bristle assembly can efficiently scrape plaque off upwardly along the tooth sides and the tooth necks for protection against periodontites and dental caries.

1. A toothbrush comprising:
a grip handle;
a crown cap mounted on a distal end of said grip handle and having a substantially L-shaped cross section and a predetermined length; and
bristle assemblies planted on inner surfaces of wings of said crown cap and having tip ends inclined at a predetermined angle toward a bent corner of said crown cap.

2. An electric toothbrush comprising:
a grip base;
a handle mounted on said grip base for reciprocating angular movement at least about an axis thereof by electric actuator means housed in said grip base;
a crown cap mounted on a distal end of said handle and having a substantially L-shaped cross section and a predetermined length; and
bristle assemblies planted on inner surfaces of wings of said crown cap and having tip ends inclined at a predetermined angle toward a bent corner of said crown cap.

3. A toothbrush or an electric toothbrush according to claim 1, wherein said crown cap has adjusting means for adjusting the projection of one of said bristle assemblies, and mounting means for mounting a distal end of said grip handle or said handle detachably on a longitudinal end of said crown cap.

4. An electric toothbrush comprising a bristle assembly reciprocally angularly movable to swing upwardly along teeth sides while being held against the teeth sides or neighboring regions, reciprocally rocking means for angularly moving said bristle assembly, and an actuator coupled to said reciprocally rocking means.

5. An electric toothbrush according to claim 4, wherein said bristle assembly is mounted in one side of a casing having a substantially inverted L shape, and a temporary positioning member mounted on the other side of said casing for temporarily positioning said bristle assembly for engagement with a tooth side.

6. An electric toothbrush according to claim 5, wherein said temporary positioning member comprises a resilient member.

7. An electric toothbrush according to claim 5, wherein said temporary positioning member comprises bristles.

8. An electric toothbrush according to claim 5, wherein said temporary positioning member is adjustable in height.

9. An electric toothbrush according to claim 4, wherein said bristle assembly comprises an upper set of bristles and a lower set of bristles, said lower set of bristles being longer than said upper set of bristles.

10. An electric toothbrush according to claim 4, wherein said bristle assembly comprises an upper set of bristles, a middle set of bristles, and a lower set of bristles, said bristles being of longer, shorter, and medium lengths successively from said lower set through said middle set to said upper set.

11. An electric toothbrush according to claim 5, wherein said bristle assembly comprises an upper set of bristles, a middle set of bristles, and a lower set of bristles, said bristles being of longer, shorter, and medium lengths successively from said lower set through said middle set to said upper set.

12. An electric toothbrush according to claim 4, wherein said temporary positioning member is adjustable in height.

13. An electric toothbrush according to claim 5, wherein said bristle assembly comprises an upper set of bristles and a lower set of bristles, said lower set of bristles being longer than said upper set of bristles.

14. An electric toothbrush according to claim 5, wherein said bristle assembly comprises an upper set of bristles, a middle set of bristles, and a lower set of bristles, said bristles being of longer, shorter, and medium lengths successively from said lower set through said middle set to said upper set.

15. An electric toothbrush according to claim 4 wherein said bristle assembly comprises an upper set of bristles, a middle set of bristles, and a lower set of bristles, said bristles being of longer, shorter, and medium lengths successively from said lower set through said middle set to said upper set.
